(19) United States
(12) Patent Application Publication
(10) Pub. No.: US 2020/0369505 A1
(43) Pub. Date: Nov. 26, 2020

(54) VARIABLE CARBONATION BEVERAGE DISPENSING SYSTEM

(71) Applicant: BILLI AUSTRALIA PTY LTD, Thomastown, Victoria (AU)

(72) Inventor: LYNTON MCKAY, THOMASTOWN , VICTORIA (AU)

(21) Appl. No.: 16/959,819

(22) PCT Filed: Dec. 21, 2018
(86) PCT No.: PCT/AU2018/051405

§ 371 Date: Jul. 2, 2020

(30) Foreign Application Priority Data
Jan. 5, 2018 (AU) 2018900028

(51) Int. Cl. B67D 1/12; B67D 1/00; B67D 1/08; B67D 1/10

(52) U.S. Cl. CPC B67D 1/1284; B67D 1/0014; B67D 1/0036; B67D 1/10; B67D 1/0074; B67D 1/0884; B67D 1/0888; B67D 1/0061

(57) ABSTRACT

A carbonated beverage dispensing system, which may be embodied as a unitary apparatus including electrically powered on-bench, under-bench or freestanding water cooling units. The system has a dispensing unit including a first source of liquid having a relatively high level of carbonation, a second source of liquid having a relative low or zero level of carbonation, a mixer in liquid connection with the first and second sources of liquid configured to mix liquid from the first and second sources, and a controllable pump to convey liquid from the first or second source of water at a variable flow rate to the mixer. The flow rate of the variable pump is controllable to provide a beverage having a variable mixture of liquids from the first and second sources of liquid to provide a beverage having a level of carbonation intermediate to that of the first and second sources of liquid.

### FIELD OF THE INVENTION

The present invention is directed generally to the field carbonated beverage dispensing systems. Such systems may be embodied in the form of a unitary apparatus including, but not exclusively, electrically powered on-bench, under-bench or freestanding water cooling units.

### BACKGROUND TO THE INVENTION

Consumers prefer many types of beverage to be carbonated. In particular, carbonated water is enjoyed as a beverage on its own, or combined with alcoholic and non-alcoholic mixers. The bubbles resulting from carbonation provide a pleasurable mouthfeel, and the slightly acidic nature confers a desirable taste.

The prior art provides a range of water cooling units having a carbonation function. These units may be further configured to dispense heated water for coffee and other beverages.

Over time, beverage consumers have become quite sophisticated with preferences emerging for the level of carbonation in a beverage. Lower levels of carbonation may be desired so as to avoid the subtle flavours a beverage being overwhelmed by vigorous bubbling and high levels of carbonic acid. Highly carbonated beverages may be difficult to drink in larger volumes given the propensity for gas bubbles to be generated in the consumer's stomach leading to an unpleasant sensation of bloating. Conversely, some consumers prefer a highly “sparkling” beverage resulting from virtual saturation of the beverage with carbon dioxide gas.

The prior art provides a number of systems for varying the carbon dioxide level of a dispensed beverage. As one example of a commercially-applicable system, U.S. Pat. No. 8,882,084 (to Cornelius Inc) discloses the use of an inline carbonation apparatus that exposes atomized water to a stream of carbon dioxide gas. The gas is solubilized into the atomized water to form a sparkling water having a set level of carbonation. To lower the level of carbonation, the carbon dioxide gas line has a solenoid valve which can be closed for a proportion of the dispensing time such that the atomized water for a given beverage volume is exposed to a lower amount of gas. A problem with this approach that is a fine level of control of carbonation control is not possible. Furthermore, constant pulsing of the solenoid valve leads to early failure.

Smaller scale home and office carbonation units are also known in the art, typically in combination with a chilled water function. Such units typically comprise a tank of water into which is contacted with carbon dioxide gas supplied under pressure by a small replaceable cylinder that is typically mounted within a cupboard. The cylinder is typically fitted with a pressure regulator with a user adjustable knob and a pressure gauge. Carbon dioxide outlet pressure is normally set between about 3 and 5 bar. These units are generally able to supply chilled water at a fixed level of carbonation, although users are able to adjust the carbonation level in a dispensed beverage by manually turning the regulator knob to increase or decrease the carbon dioxide pressure. This procedure involves opening cupboard door, bending down and reaching inside cupboard space to locate regulator. The carbon dioxide cylinder is often mounted on the rear of a cupboard and is therefore difficult to reach.

The pressure adjustment procedure described above is clearly awkward, and is generally only performed when the user first installs the unit, or after a cylinder has been changed. It would be entirely impractical to perform the adjustment procedure each time a user wished to alter the carbonation level of a beverage.

A need therefore exists for a small scale beverage dispensing system that has means for controlling the level of carbonated water in a dispensed beverage. There is a further need to ensure that where a desired level of carbonation is changed (for example where a user chooses a level different than that set by the previous user), the output beverage is quickly altered to the new level.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY OF THE INVENTION

In a first aspect, but not necessarily the broadest aspect, the present invention provides a beverage dispensing unit comprising: a first source of liquid having a relatively high level of carbonation, a second source of liquid having a relative low or zero level or carbonation, mixing means in liquid connection with the first and second sources of liquid configured to allow mixing of liquid from the first and second sources, and a controllable pump configured to convey liquid from the first or second source of water at a variable flow rate to the mixing means, wherein the unit is configured such that the flow rate of the variable pump is controllable so as to provide a beverage having a variable mixture of liquids from the first and second sources of liquid so as to provide a beverage having a level of carbonation intermediate to that of the first and second sources of liquid.

In one embodiment of the first aspect, the variable pump is functionally disposed between the first or second source of water and the mixing means.

In one embodiment of the first aspect, the variable pump is controllable by electrical or electronic signal.

In one embodiment of the first aspect, the variable pump has an electric motor and the flow rate is variable by altering the rate of rotation of the electric motor.

In one embodiment of the first aspect, the beverage dispensing unit comprises a first conduit conveying liquid from the first source of liquid to the mixing means, and a second conduit conveying liquid from the second source of liquid to the mixing means.

In one embodiment of the first aspect, the mixing means is a space formed at the junction of the first and second conduits.

In one embodiment of the first aspect, the first conduit has a controllable valve and/or the second conduit has a controllable valve.

In one embodiment of the first aspect, the beverage dispensing unit comprises a dispensing spout in liquid connection with the mixing means.

In one embodiment of the first aspect, the beverage dispensing unit comprises a flow restricting means disposed functionally between the mixing means and the dispensing spout.

In one embodiment of the first aspect, the first source of liquid is a tank of carbonated water.

In one embodiment of the first aspect, the tank is configured to hold the carbonated water under pressure.

In one embodiment of the first aspect, the second source of water is substantially municipal water.

In one embodiment of the first aspect, the beverage dispensing unit comprises liquid cooling means configured to cool (i) liquid in or from the first source of liquid and (ii) liquid in or from the second source of liquid.

In one embodiment of the first aspect, the liquid cooling means is a cooling block that is cooled by a refrigeration circuit.

In one embodiment of the first aspect, the beverage dispensing unit comprises a processor and processor-executable software configured to accept user input relating to a desired level of carbonation.

In one embodiment of the first aspect, the beverage dispensing unit may comprise a user interface in data communication with the processor configured to accept user input relating to a desired level of carbonation.

In one embodiment of the first aspect, the beverage dispensing unit comprises electronic memory having stored therein a relationship to allow for a desired ratio of liquids from the first and second sources of liquid to be mixed.

In one embodiment of the first aspect, the relationship is a mathematical relationship or a lookup table.

In one embodiment of the first aspect, the beverage dispensing unit comprises liquid heating means.

In one embodiment of the first aspect, the refrigeration circuit comprises a condenser and the beverage dispensing unit is configured such that heat output by the condenser is used to heat water in or bound for the water heating means.

In a second aspect, the present invention provides a method of dispensing a liquid having a desired level of carbonation, the method comprising: entering a desired level of carbonation into the user interface of the beverage dispensing unit of any embodiment of the first aspect and causing or allowing the beverage dispensing unit to dispense a beverage.

### BRIEF DESCRIPTION OF THE DRAWINGS

The various embodiments of the invention shown in each of the drawings are not intended to show complete and operable forms of the invention. Moreover, each of the components of the embodiments of the drawings are not drawn to scale. The components are drawn so as to show functional relationships therebetween. Solid arrowed lines represent the direction of water, while arrowed dashed lines show the direction of data flow.

FIG. 1 shows a schematic diagram of a preferred water dispenser of the present invention capable of dispensing water having a user-specified level of carbonation.

FIG. 2 shows a schematic diagram of the preferred water dispenser shown in FIG. 1 with the addition of a water filter and return valves.

FIG. 3 shows a schematic diagram of the preferred water dispenser shown in FIG. 1 that is capable of providing heated water. In this embodiment, heat recovered from the refrigeration circuit is used to preheat water in the heated water circuit.

### DETAILED DESCRIPTION OF THE INVENTION

Reference throughout this specification to “one embodiment” or “an embodiment” or similar wording means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and from different embodiments, as would be understood by those in the art.

In the claims below and the description herein, any one of the terms “comprising”, “comprised of” or “which comprises” is an open term that means including at least the elements/features that follow, but not excluding others. Thus, the term comprising, when used in the claims, should not be interpreted as being limitative to the means or elements or steps listed thereafter. For example, the scope of the expression a method comprising step A and step B should not be limited to methods consisting only of methods A and B. Any one of the terms “including” or “which includes” or “that includes” as used herein is also an open term that also means including at least the elements/features that follow the term, but not excluding others. Thus, “including” is synonymous with and means “comprising”.

The invention has been described with reference to certain advantages. It is not suggested or represented that each embodiment of the invention have all of the advantages described. Any particular embodiment may have only a single advantage. In some embodiments, the invention may provide no advantage and merely provide a useful alternative to the prior art.

With a view to solving one or problems of the prior art, or providing an alternative to the prior art the Applicant has found that a beverage having a desired level of carbonation may be provided by a dispenser configured to mix two liquids each having a different level of carbonation so as to provide a beverage having an intermediate level of carbonation. This approach is divergent from prior art dispensers which function to expose a single beverage liquid to differing amounts of carbon dioxide gas.

Applicant has further recognised that mixing two liquids having different levels of carbonation creates a problem in that there is some practical difficulty in effecting the mixing to rapidly accurately provide a beverage having a desired level of carbonation. Applicant has found that the use of a variable displacement pump (the displacement preferably being variable by electric or electronic means) in relation to at least one of the two liquids. The pump speed (for example) may be varied so as to provide more or less of one of the liquids in relation to the other. The pump speed may be varied in slight increments or even substantially continuously so as to provide a high level of control over the proportions of the two liquids, and in turn fine control over the level of carbonation in the dispensed beverage. The response to any alteration in pump speed is preferably substantially instantaneous thereby limiting any lag time between the output of a beverage having a first level of carbonation to a beverage have a second level of carbonation.

The variable pump may comprise on-board controller allowing for the flow rate to be varied according to a signal (analogue or digital) provided by another component of the beverage dispenser. For example, the dispenser may have microcontroller capable of providing digital output instructing the pump to operate at a certain flow rate.

As an alternative, the pump may be varied directly by variation of the voltage used to drive the pump. Variable voltage output means may be provided in the dispenser, and controlled directly by a user or alternatively controlled by a microcontroller of the dispenser.

In mixing the two liquids, Applicant has recognised a further problem in that one liquid may be at a different pressure to the other, thereby causing difficulty in equalising the rate of flow of the two liquids into a mixing space. It has been discovered that a flow restriction means disposed downstream of the mixing space provides an equal resistance to the flow of both liquids thereby limiting the opportunity for one liquid flow into the space at the expense of the other.

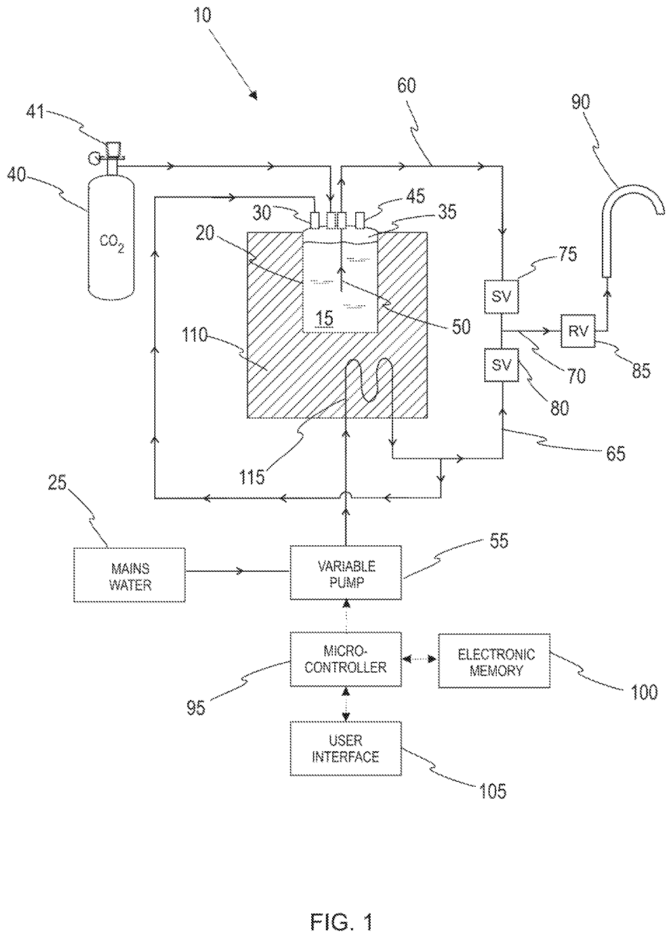

Reference is now made to FIG. 1 showing schematically the components of a preferred beverage dispenser 10 of the type used for small-scale chilled water production in a domestic or office environment. The beverage dispenser (10) is capable of producing chilled water having a desired level of carbonation by mixing highly carbonated water with uncarbonated water.

The highly carbonated water (15) is prepared and stored in tank (20) until use. The highly carbonated water (15) is prepared by spraying water (obtained from mains supply (25)) through injector (30) into the headspace (35) of tank (20). The headspace (35) is occupied by high pressure carbon dioxide gas provided by replaceable cylinder (40) having a pressure regulator (41). The water spray (not shown) provide a high surface area via which carbon dioxide gas can diffuse and thereby enter solution.

The pressure of carbon dioxide gas in the headspace (35) is set according to the maximum level of carbonation desired by a user. As will be appreciated, a higher gas pressure shifts the solution/dissolution equilibrium in favour of gas solution, thereby increasing the level of gas dissolved in the water (15).

The carbon dioxide gas pressure in the head space (35) is initially set by the adjustment of the cylinder (40) pressure regulator (41) and is typically set between 3 and 5 bar. As carbonated water is drawn by a user via dispensing spout (90), the water level in the tank (20) falls. As a result carbon dioxide gas pressure within the headspace (35) drops and fresh gas is dispensed from the cylinder (40) into the head space (35) to equalize gas pressure back to the pressure set by regulator (41).

At a predetermined lower water level, a level sensor (not shown) located in the top of the carbonator tank, causes the actuation of pump (55). Pump (55) creates a water pressure which is higher than the carbon dioxide pressure in the head space (35) and causes water to flow into the tank (20). The water level in the tank (20) then rises until a predetermined upper level is reached, as measured by the level sensor, and the pump (55) is then stopped. To maximize the infusion of carbon dioxide into the water, the refill rate of the carbonator is typically less than the delivery rate of carbonated water from the dispensing spout (90).

In circumstances where a large amount of water is drawn from the dispensing spout (90), it is possible for the water level in the tank (20) to fall to the lower terminus of conduit (50), at which point flow of carbonated water ceases and carbon dioxide gas may instead be discharged from the spout (90). At this low level, the head space (35), which has now become large, is still filled with carbon dioxide gas at the pressure determined by the cylinder regulator (41).

As the tank (20) is being refilled with water by pump (55), the carbon dioxide pressure inside the tank (20) rises as the gas is compressed by the displacement of the incoming water. Carbon dioxide pressure inside the tank (20) can rise to a maximum of 8 bar at which point the pressure relief valve (45) opens to limit any further pressure rise.

During normal operation (where a single cup of water is drawn from the spout (90)), the carbon dioxide in the head space (35) during water refill would be typically compressed about 1 bar above the regulator (41) set point. As soon as carbonated water is drawn from the spout (90), this pressure in the head space (35) quickly drops back to the regulated carbon dioxide pressure.

As the same pump (55) is used to boost the flow of uncarbonated water as well as to refill the tank (20), the carbonation will not be refilled whilst the uncarbonated water valve (80) is open. This applies in circumstances where uncarbonated water only, or mixed water, is being drawn from the spout (90).

A conduit (50) extends into the body of carbonated water (15), acting to convey water to outside the tank (20). Given that the tank (20) is pressurized, water flows upwardly through the conduit (50) upon opening of valve (75).

The uncarbonated water originates also from mains water (25), which is fed via a conduit into a variable volume displacement pump (55). Variable pump (55) is powered by a brushless DC motor that is operable over a range of voltages. A relatively low voltage applied to the DC motor results in a relatively slow rate of rotation, and therefore displacement of a relatively low volume of water. In the context of the present invention, the uncarbonated water acts as a diluent for the highly carbonated water, and accordingly fine control of the volume of uncarbonated water mixed with a fixed volume of carbonated water allows for delivery of a water having an intermediate level of carbonation. The variable displacement pump (55) provides for fine control of volume, and accordingly delivery of water at a desired level of carbonation with some precision.

The pump (55) may be a vane pump, of the kind known in the field of beverage dispensing machines. The pump (55) may be further capable of developing a pressure of up to around 10 bar. An exemplary pump (55) is a GA series vane pump, and particularly model GA1114 (Fluid-o-Tech; Italy). The GA series pumps are a relatively small capacity rotary vane pump, powered by a brush or brushless DC motor. The internal parts are fabricated in food grade stainless steel and carbon graphite. The nominal flow rates range between 30 and 100 l/h at 1450 rpm. Pump speed may be varied between 500 and 3000 rpm and flow rate will vary proportionally to speed.

As will be appreciated, the rate of displacement of the variable pump (55) may be continuously varied while the pump is running, and accordingly the ratio of uncarbonated water carbonated water can be quickly altered. This allows for the carbonation level of the dispensed water (being a mixture of carbonated and uncarbonated water) to be rapidly increased or decreased. In this way, a first user may choose to dispense a water having a low level of carbonation, and in which case the variable pump is running at a high rate, such that a relatively high volume of uncarbonated water is mixed with the carbonated water. A second subsequent user may choose a highly carbonated water, and in which case a decreased voltage is applied to the variable pump (55) so as to provide a relatively low volume of uncarbonated water compared with carbonated water. The decrease in voltage provides a substantially instantaneous decrease in the rate of displacement of uncarbonated water, and hence a quick transition from a low to a high level of carbonation in the mixed water that is dispensed by the unit.

As will be appreciated, the dispensing unit may be configured such that variable pump (55) controls the displacement of the carbonated water rather than the uncarbonated water. In that circumstance the application of a relatively low voltage to the variable pump leads to displacement of relatively low volume of carbonated water, and therefore the dispensing of a water having a relatively low level of carbonation.

In some embodiments of the invention, each of the carbonated and uncarbonated water has a dedicated variable displacement pump.

As foreshadowed supra, water having high carbonation is mixed with water having no carbonation to form a beverage of intermediate carbonation. Preferably the mixing is by passive means and in this preferred embodiment occurs at the junction of conduit (60) (carrying highly carbonated water) and conduit (65) (carrying uncarbonated water) such that the water carried by conduit (70) contains water having an intermediate level of carbonation. As an alternative to the aforementioned arrangement, the conduits (60) and (65) may remain separate with the waters mixing only after exiting the spout (90), for example in a drinking glass placed under the spout (90).

Solenoid valves (75) and (80) are disposed inline on the highly carbonated water flow path (conduit 60) and the uncarbonated water flow path (conduit 65) respectively. Valves (75) and (80) are normally open when a beverage is being dispensed so as to not impede the passage of water egressing from the tank (20) or the variable pump (55). In this way, the control of carbonation is achieved by variation of the rate of displacement of pump (55). Where a user desires completely uncarbonated water, valve (75) may be closed (typically by a signal originating from a microprocessor) while valve (80) remains open. Conversely, where a user desires water having the maximum level of carbonation available, valve (80) may be closed while valve (75) remains open.

A flow restrictor (in this embodiment being the restrictor valve (85)) is placed inline on conduit (70) acting to restrict the flow rate of the mixed waters therethrough. Restriction of the flow rate of the mixed water prevents the rapid expulsion of the mixed water from conduit (70) and out of the dispensing spout (90).

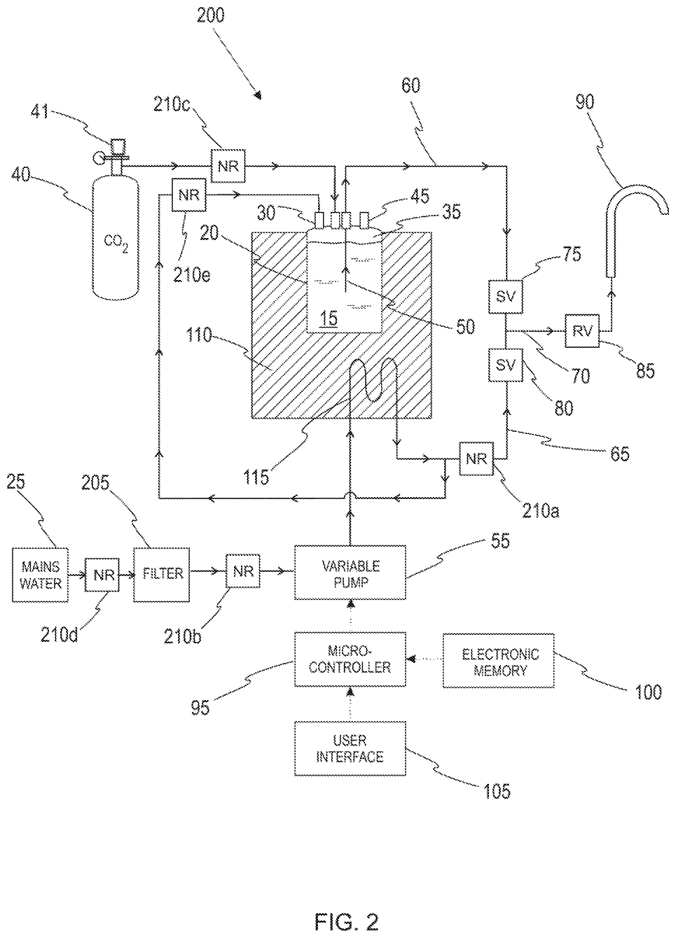

The principle of operation relates to characteristic of the pump (55) as a direct displacement type and the restrictor (85) permits a fixed flow rate at a given pressure. Opening both solenoid valves (75) and (80) at the same time basically equalizes the entire circuit line pressure between the pump and the restrictor (85). The pressure will be equal to the carbon dioxide gas pressure in the tank (20). In situations where the pump (55) is off, a check valve (shown as (210a) in FIG. 2) prevents back flow through the pump. The mains water pressure before the pump (55) is limited (limiter not shown) to 3 bar. Carbon dioxide pressure is maintained above 3 bar such that no water will enter the carbonation circuit unless it is pressurized by pump (55).

When pump (55) starts to run, being a positive displacement type of pump, a certain volume of water per pump revolution is delivered into the circuit, irrespective of pressure (assuming no pump seal leakage). With the pump (55) running slowly, the volume delivery may be considerably less the 2.5 L/m rating of restrictor (85) at carbon dioxide tank (20) pressure. In this situation, the total mix of water which passes through restrictor (85) will be the volume of water that is pumped by pump (55) which is fed through valve (80) and the balance of the flow up to 2.5 L/m will be supplied from the carbonation tank (20), through valve (75). As the pump (55) speed is increased, the flow from the pump (55) through valve (80) will be increased proportionally. During this time, the pressure in the circuit remains constant at the carbon dioxide gas pressure. As the flow rate through restrictor (85) remains at 2.5 L/m, an increase in flow from the pump (55) causes a corresponding decrease in the flow from the carbonation tank (20).

The water inlet to the carbonating tank (20) incorporates a flow orifice which causes water flow to be biased toward passing through valve (80) rather than entering the carbonating tank (20).

In this exemplary embodiment the restrictor valve allows a flow rate of no more than about 2.5 l/min.

Dispensing of water is under the control of a user by activation of valves (75) (80), which in turn are controlled by a microcontroller. Typically, a simple lever-activated switch is provided about the spout (90), the switch being in electrical connection with the microcontroller.

As will be clear from the foregoing, the variability of the water displaced by pump (55) allows for the rapid alteration of the carbonation level of water dispensed by the spout (90). Variation of displacement may be controlled by any means deemed suitable by the skilled artisan having benefit of the present specification.

In one embodiment, the rate of displacement may be controlled directly by a user. For example, a rotary potentiometer having a user readable scale may be provided, whereby the user rotates the potentiometer so as to increase or decrease the voltage applied to the motor of the variable pump (55). The alteration in voltage varying the displacement rate of the pump (55) leading to a proportional alteration in the ratio of carbonated water to uncarbonated water exiting the dispensing spout (90).

In the preferred embodiment of FIG. 1, the variable pump (55) is controlled by a microcontroller (95) under the instruction of software stored in electronic memory (100). The user is presented with a user interface (105) which is in data communication with the microcontroller (95). When a user wishes to dispense a beverage having a desired level of carbonation, the user enters the desired level into the interface (105). The desired level may be expressed quantitatively (e.g. as a percentage) or qualitatively (e.g. low/medium/high). The desired carbonation level is communicated to the microcontroller (95) which, having reference to software stored in electronic memory (100), sets the input voltage of the variable pump (55) to a value capable of providing the appropriate ratio of carbonated and uncarbonated water.

Electronic memory (100) has stored therein a relationship between the user input and the variable pump input voltage required to achieve the level of carbonation specified by the user input. That stored relationship may be in the form of a mathematical relationship (e.g. relating % carbonation level to voltage) or a look up table (e.g. each of relating low, medium, high to a different predetermined voltage). Typically, the relationship will be based on empirical data obtained using the specific physical configuration (and possibly other parameters such as water temperature) of the dispensing unit concerned.

As will be understood, the methods and systems described herein may be deployed in part or in whole through one or more processors that execute computer software, program codes, and/or instructions on a processor. A processor may be any kind of computational or processing device capable of executing program instructions, codes, binary instructions and the like. The processor may be or may include a signal processor, digital processor, embedded processor, microprocessor or any variant such as a coprocessor (math co-processor, graphic co-processor, communication co-processor and the like) and the like that may directly or indirectly facilitate execution of program code or program instructions stored thereon. In addition, the processor may enable execution of multiple programs, threads, and codes.

The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere.

Any processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of memory, disk, flash drive, RAM, ROM, cache and the like.

The computer software, program codes, and/or instructions may be stored and/or accessed on computer readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks. Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on computers through computer executable media having a processor capable of executing program instructions stored thereon as a monolithic software structure, as standalone software modules, or as modules that employ external routines, code, services, and so forth, or any combination of these, and all such implementations may be within the scope of the present disclosure.

Furthermore, the elements depicted in any flow chart or block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a computer readable medium.

The application software may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

The invention may be embodied in program instruction set executable on one or more computers. Such instructions sets may include any one or more of the following instruction types:

Data handling and memory operations, which may include an instruction to set a register to a fixed constant value, or copy data from a memory location to a register, or vice-versa, to store the contents of a register, result of a computation, or to retrieve stored data to perform a computation on it later, or to read and write data from hardware devices.

Arithmetic and logic operations, which may include an instruction to add, subtract, multiply, or divide the values of two registers, placing the result in a register, possibly setting one or more condition codes in a status register, to perform bitwise operations, e.g., taking the conjunction and disjunction of corresponding bits in a pair of registers, taking the negation of each bit in a register, or to compare two values in registers (for example, to determine if one is less, or if they are equal).

Control flow operations, which may include an instruction to branch to another location in the program and execute instructions there, conditionally branch to another location if a certain condition holds, indirectly branch to another location, or call another block of code, while saving the location of the next instruction as a point to return to.

Coprocessor instructions, which may include an instruction to load/store data to and from a coprocessor, or exchanging with CPU registers, or perform coprocessor operations.

A processor of a computer of the present system may include “complex” instructions in their instruction set. A single “complex” instruction does something that may take many instructions on other computers. Such instructions are typified by instructions that take multiple steps, control multiple functional units, or otherwise appear on a larger scale than the bulk of simple instructions implemented by the given processor. Some examples of “complex” instructions include: saving many registers on the stack at once, moving large blocks of memory, complicated integer and floating-point arithmetic (sine, cosine, square root, etc.), SIMD instructions, a single instruction performing an operation on many values in parallel, performing an atomic test-and-set instruction or other read-modify-write atomic instruction, and instructions that perform ALU operations with an operand from memory rather than a register.

An instruction may be defined according to its parts. According to more traditional architectures, an instruction includes an opcode that specifies the operation to perform, such as add contents of memory to register—and zero or more operand specifiers, which may specify registers, memory locations, or literal data. The operand specifiers may have addressing modes determining their meaning or may be in fixed fields. In very long instruction word (VLIW) architectures, which include many microcode architectures, multiple simultaneous opcodes and operands are specified in a single instruction.

Some types of instruction sets do not have an opcode field (such as Transport Triggered Architectures (TTA) or the Forth virtual machine), only operand(s). Other unusual “0-operand” instruction sets lack any operand specifier fields, such as some stack machines including NOSC.

Conditional instructions often have a predicate field—several bits that encode the specific condition to cause the operation to be performed rather than not performed. For example, a conditional branch instruction will be executed, and the branch taken, if the condition is true, so that execution proceeds to a different part of the program, and not executed, and the branch not taken, if the condition is false, so that execution continues sequentially. Some instruction sets also have conditional moves, so that the move will be executed, and the data stored in the target location, if the condition is true, and not executed, and the target location not modified, if the condition is false. Similarly, IBM z/Architecture has a conditional store. Some instruction sets include a predicate field in every instruction; this is called branch predication.

The instructions constituting a program are rarely specified using their internal, numeric form (machine code); they may be specified using an assembly language or, more typically, may be generated from programming languages by compilers.

Beverage consumers typically expect that water output by a dispensing unit will be cooled to some extent. Accordingly, the preferred embodiment of FIG. 1 provides means for cooling the water output via the spout (90). This preferred dispensing unit provides a metallic cooling block (110) which is in thermal communication with the carbonated water (15) via the wall of tank (20). Accordingly, water output via conduit (50) is already cooled to a desired temperature (such as 5, 6, 7, 8, 9, 10, 11, 12, 13, 14 or 15° C.). The cooling block (110) is itself cooled by a refrigeration circuit of the type known well to the skilled artisan. Typically an evaporator coil (not shown in this drawing) is in thermal contact with the cooling block, the evaporator coil having a liquid refrigerant moving therethrough which extracts latent heat of vaporization from the cooling block in transitioning from the liquid phase to the vapour phase.

The cooling block (110) is preferably used also to cool that uncarbonated mains water exiting the variable pump (55). The water may be conveyed through a coil (115) fabricated from a heat transfer material such as copper so as to transfer heat energy from the water into the cooling block (110).

A more highly preferred dispensing unit (200) having additional components is shown in FIG. 2. A filter (205) may be included to remove any one of more of suspended solids, ions, organic compounds, bacteria, viruses or parasites. Non-return valves (210) are provided to prevent back flow into the mains water supply (210d) and to control the flow of water within the unit (200) (210a, 210b, 210c, 210e).

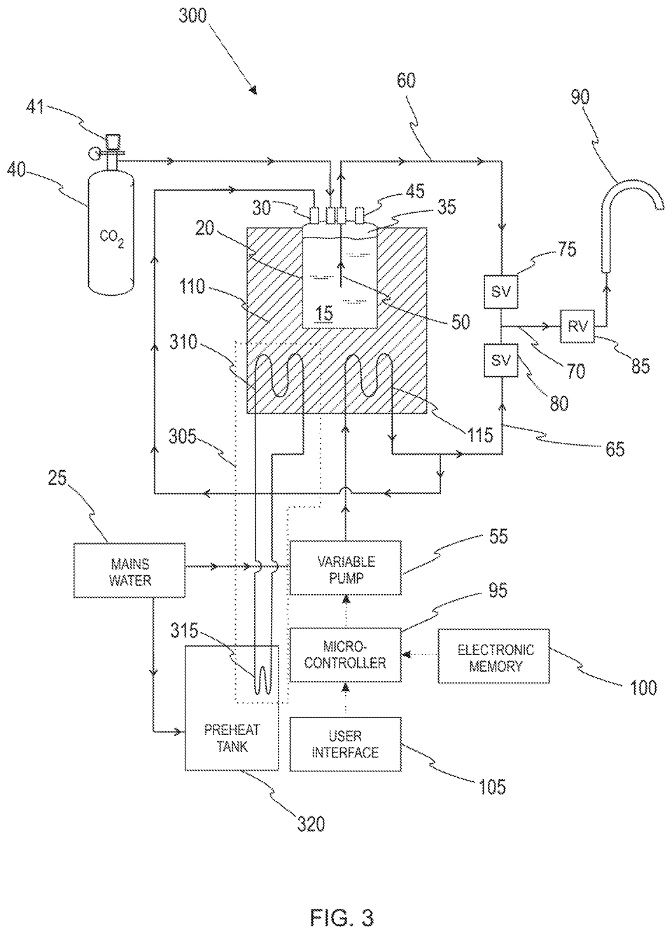

The preferred embodiment of FIG. 3 shows a dispensing unit (300) capable of producing chilled carbonated water and also heated water for coffee or tea. In this drawing, the refrigeration circuit (305) present in the embodiments of FIG. 1 and FIG. 2 is shown. The refrigeration circuit (305) comprises an evaporator coil (310) configured to extract thermal energy from the cooling block (110), and a condenser coil (315) configured to dissipate heat from the refrigeration circuit (305). The compressor of the refrigeration circuit (305) comprises a compressor (not shown to improve clarity of the drawing).

In the preferred embodiment of FIG. 3, heat energy released by the condenser coil (315) is used to preheat incoming mains water in a preheat tank (320). This preheated water is conveyed to a main water heating tank (not shown) where temperature is elevated to near boiling. Thus, condenser heat that would normally be lost to the environment is instead recovered and used to preheat water thereby decreasing the amount of energy used to produce near boiling water.

The present invention has been described in detail in relation to a preferred water dispensing unit. It will be appreciated that the present invention may be applied to liquids other than substantially pure water. For example, any of the water flowing through the present beverage dispensing unit may comprise a flavour (so as to provide a soda-type beverage for example) or a salt (to provide a sparkling mineral-type water for example) or a dietary supplement (to provide a health drink for example) or an alcoholic fluid (to provide a sparkling wine for example).

While the invention has been disclosed in connection with the preferred embodiments shown and described in detail, various modifications and improvements thereon will become readily apparent to those skilled in the art.

Accordingly, the spirit and scope of the present invention is not to be limited by the foregoing examples, but is to be understood in the broadest sense allowable by law.

1. A beverage dispensing unit comprising:
a first source of liquid having a relatively high level of carbonation,
a second source of liquid having a relative low or zero level of carbonation,
a mixing element in liquid connection with the first and second sources of liquid configured to allow mixing of liquid from the first and second sources, and
a controllable pump configured to convey liquid from the first or second source of water at a variable flow rate to the mixing element,
wherein the unit is configured such that the flow rate of the variable pump is controllable so as to provide a beverage having a variable mixture of liquids from the first and second sources of liquid so as to provide a beverage having a level of carbonation intermediate to that of the first and second sources of liquid.

2. The beverage dispensing unit of claim 1, wherein the variable pump is functionally disposed between the first or second source of water and the mixing element.

3. The beverage dispensing unit of claim 1, wherein the variable pump is controllable by electrical or electronic signal.

4. The beverage dispensing unit of claim 1, wherein the variable pump has an electric motor and the flow rate is variable by altering the rate of rotation of the electric motor.

5. The beverage dispensing unit of claim 1, comprising a first conduit conveying liquid from the first source of liquid to the mixing element, and a second conduit conveying liquid from the second source of liquid to the mixing element.

6. The beverage dispensing unit of claim 5, wherein the mixing element is a space formed at the junction of the first and second conduits.

7. The beverage dispensing unit of claim 5, wherein the first conduit has a controllable valve and/or the second conduit has a controllable valve.

8. The beverage dispensing unit of claim 1, comprising a dispensing spout in liquid connection with the mixing element.

9. The beverage dispensing unit of claim 8, comprising a flow restriction disposed functionally between the mixing element and the dispensing spout.

10. The beverage dispensing unit of claim 1, wherein the first source of liquid is a tank of carbonated water.

11. The beverage dispensing unit of claim 10, wherein the tank is configured to hold the carbonated water under pressure.

12. The beverage dispensing unit of claim 1, wherein the second source of water is substantially municipal water.

13. The beverage dispensing unit of claim 1 comprising liquid cooler configured to cool (i) liquid in or from the first source of liquid and (ii) liquid in or from the second source of liquid.

14. The beverage dispensing unit of claim 13 wherein the liquid cooler is a cooling block that is cooled by a refrigeration circuit.

15. The beverage dispensing unit of claim 1 comprising a processor and processor-executable software configured to accept user input relating to a desired level of carbonation.

16. The beverage dispensing unit of claim 15, comprising a user interface in data communication with the processor configured to accept user input relating to a desired level of carbonation.

17. The beverage dispensing unit of claim 15, comprising electronic memory having stored therein a relationship to allow for a desired ratio of liquids from the first and second sources of liquid to be mixed.

18. The beverage dispensing unit of claim 17, wherein the relationship is a mathematical relationship or a lookup table.

19. The beverage dispensing unit of claim 1 comprising a liquid heater.

20. The beverage dispensing unit of claim 14, comprising a liquid heater and wherein the refrigeration circuit comprises a condenser and the beverage dispensing unit is configured such that heat output by the condenser is used to heat water in or bound for the liquid heater.

21. (canceled)
